(19) United States
(12) Patent Application Publication
(10) Pub. No.: US 2025/0328723 A1
(43) Pub. Date: Oct. 23, 2025

(54) COMMUNICATION SYSTEM, SERVER FOR COMMUNICATION SYSTEM, AND USER REGISTRATION METHOD

(71) Applicant: BROTHER KOGYO KABUSHIKI KAISHA, Nagoya (JP)

(72) Inventors: Kazuki TSUJI, Nagoya (JP); Katsuaki ITO, Nagoya (JP)

(21) Appl. No.: 19/173,133

(22) Filed: Apr. 8, 2025

(30) Foreign Application Priority Data
Apr. 19, 2024 (JP) 2024-068396

(51) Int. Cl. G06F 40/174; G06Q 30/012; H04N 1/00

(52) U.S. Cl. CPC G06F 40/174; G06Q 30/012; H04N 1/00244; H04N 1/00344; H04N 2201/0094

(57) ABSTRACT

A communication system includes a terminal device and a server. The terminal device has a display unit to present an input screen with multiple input elements and an operation unit to receive user inputs. The server includes a storage device storing user information, including data corresponding to multiple input items. When the input screen is displayed, the system obtains input data and determines an index value based on proximity between the input data and stored user information. The system displays an indicator reflecting the index value on the input screen. Upon receiving a registration instruction, the system determines whether a registration condition is met by comparing the input data with stored user information. If the condition is satisfied, the system completes user registration by storing the input data as new user information. If not, registration is not completed. This configuration enables dynamic feedback and validation during user registration.

### REFERENCE TO RELATED APPLICATIONS

This application claims priority from Japanese Patent Application No. 2024-068396 filed on Apr. 19, 2024. The entire content of the priority application is incorporated herein by reference.

### BACKGROUND ART

The present disclosure relates to a communication system, a server for the communication system, and a user registration method.

### SUMMARY

One known conventional information processing system is configured to provide a membership registration form to facilitate user registration. This system displays an input form on a terminal device, where multiple input elements are presented for the user to input data. However, in this system, if the user makes an attempt to register but the registration is rejected, the entered data is cleared, requiring the user to re-enter data into the multiple input elements in order to make another attempt for registration. This may lead to increased frustration when registration is unsuccessful.

According to aspects of the present disclosure, there is provided a communication system that includes a terminal device and a server. The terminal device includes a display unit configured to display an image and an operation unit configured to receive user operations. The server includes a storage device configured to store user information of registered users, wherein the user information includes data corresponding to multiple input items. The system is configured to execute a process in which the display unit of the terminal device displays an input screen including multiple input elements, each configured to receive data corresponding to one of the multiple input items. During an input state, in which the input screen is displayed to allow data input to each of the multiple input elements before a registration instruction is received, the system obtains data having been input into at least one of the multiple input elements. During the input state, the system determines an index value based on a proximity between the obtained data and the registered user information stored in the storage device. The system also causes the display unit of the terminal device to display an indicator, which is a visualization based on the index value, on the input screen that is being displayed on the display unit. In response to receiving a registration instruction in association with the data corresponding to the multiple input items having been input to the multiple input elements, the system determines whether a registration condition is satisfied. The determination is based on a comparison between the received data corresponding to the multiple input items and the data corresponding to the multiple input items included in the user information stored in the storage device. When the registration condition is satisfied, the system completes user registration by storing the user information, including the received data corresponding to the multiple input items, into the storage device as user information for a newly registered user. However, when the registration condition is not satisfied, the user registration is not completed.

According to aspects of the present disclosure, there is provided a server configured to communicate with a terminal device. The terminal device includes a display unit configured to display an image and an operation unit configured to receive user operations. The server comprises a storage device configured to store user information of registered users, wherein the user information includes data corresponding to multiple input items. The server further includes a controller. The controller is configured to execute a process in which the display unit of the terminal device displays an input screen including multiple input elements, each configured to receive data corresponding to one of the multiple input items. During an input state, in which the input screen is displayed to allow data input to each of the multiple input elements before a registration instruction is received, the controller obtains data having been input into at least one of the multiple input elements. During the input state, the controller determines an index value based on a proximity between the obtained data and the registered user information stored in the storage device. The controller also causes the display unit of the terminal device to display an indicator, which is a visualization based on the index value, on the input screen being displayed on the display unit. In response to receiving a registration instruction in association with the data corresponding to the multiple input items having been input to the multiple input elements, the controller determines whether a registration condition is satisfied. The determination is based on a comparison between the received data corresponding to the multiple input items and the data corresponding to the multiple input items included in the user information stored in the storage device. When the registration condition is satisfied, the controller completes user registration by storing the user information, including the received data corresponding to the multiple input items, into the storage device as user information for a newly registered user. However, when the registration condition is not satisfied, the user registration is not completed.

According to aspects of the present disclosure, there is provided a user registration method for a communication system. The communication system includes a terminal device provided with a display unit configured to display an image and an operation unit configured to receive user operations. The system further includes a server comprising a storage device configured to store user information of registered users, wherein the user information includes data corresponding to multiple input items. The method includes a process in which the display unit of the terminal device displays an input screen including multiple input elements, each configured to receive data corresponding to one of the multiple input items. During an input state, in which the input screen is displayed to allow data input to each of the multiple input elements before a registration instruction is received, the method includes obtaining data having been input into at least one of the multiple input elements. During the input state, the method further includes determining an index value based on a proximity between the obtained data and the registered user information stored in the storage device. The method also includes causing the display unit to display an indicator, which is a visualization based on the index value, on the input screen being displayed on the display unit. In response to receiving a registration instruction in association with the data corresponding to the multiple input items having been input to the multiple input elements, the method includes determining whether a registration condition is satisfied. The determination is based on a comparison between the received data corresponding to the multiple input items and the data corresponding to the multiple input items included in the user information stored in the storage device. When the registration condition is satisfied, the method includes completing user registration by storing the user information, including the received data corresponding to the multiple input items, into the storage device as user information for a newly registered user. However, when the registration condition is not satisfied, the user registration is not completed. When the user enters a registration instruction after inputting data for multiple items into the input screen, the user may experience frustration if the user registration is not performed due to the registration condition not being satisfied. This may occur because the user perceives that the input effort was wasted.

According to the above-described configuration, during the input state, an index value is determined based on the data already entered in the input screen, where the index value indicates the likelihood of the user registration being permitted. Furthermore, suitability information, which is determined based on the index value, is displayed on the input screen. As a result, the user can recognize, to some extent, the likelihood of the user registration being permitted while entering the data. Accordingly, the user may choose to abandon the registration process during data entry. Additionally, even if the user registration is not performed after the user enters the registration instruction, the user can anticipate the outcome, making it less likely for the user to feel frustration. Thus, in cases where the user is required to input data into the input screen for user registration, this configuration can reduce the frustration that the user may experience.

### BRIEF DESCRIPTION OF DRAWINGS

FIG. 1 is a block diagram showing a configuration of a communication system.

FIG. 2 is a diagram illustrating a management database.

FIGS. 3 and 4 show a sequence diagram of a user registration process in Service 1.

FIG. 5 shows an example of an input screen.

FIG. 6 is a flowchart illustrating a registration difficulty indicator update process.

FIG. 7A shows an example of a registration completion screen.

FIGS. 7B and 7C show examples of a registration failure notification screen.

FIG. 8 is a flowchart illustrating a registration failure notification generation process.

### DESCRIPTION

### A. Embodiment

### A1. System Configuration

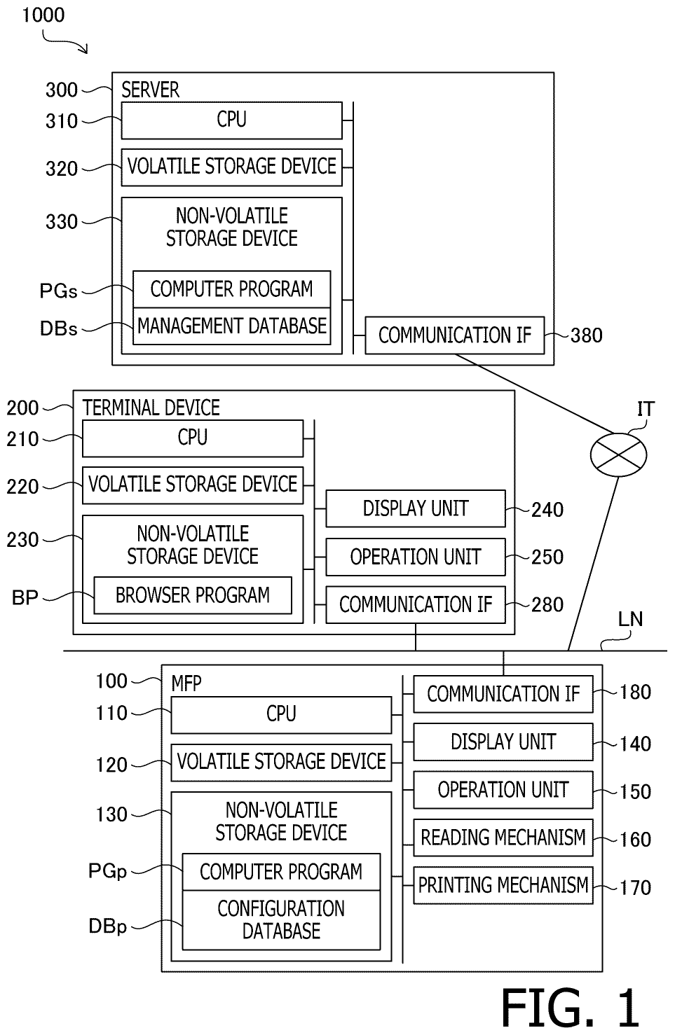

FIG. 1 is a block diagram showing a configuration of a communication system 1000. The communication system 1000 includes a multifunction periphery (hereinafter referred to as “MFP”) 100, a terminal device 200, and a server 300 that is configured to provide a service utilizing the MFP 100.

The MFP 100 is a device having a function to perform printing by consuming ink as a printing material. The MFP 100 includes a controller including a CPU 110, a volatile storage device 120 such as DRAM, and a non-volatile storage device 130 such as a hard disk or a flash memory. The MFP 100 further includes a display unit 140, such as a liquid crystal display, an operation unit 150, provided with buttons and/or a touch panel for receiving user operations, a reading mechanism 160, a printing mechanism 170, and a communication interface (IF) 180.

The communication IF 180 is an interface for connecting to the Internet IT. The communication IF 180 may include a wired interface compliant with Ethernet (a registered trademark of Xerox Corporation) or a wireless interface compliant with the Wi-Fi standard (a registered trademark of the Wi-Fi Alliance), but is not limited thereto.

The CPU 110 functions as a processor that performs data processing. The volatile storage device 120 provides a buffer area for temporarily storing various intermediate data generated during processing by the CPU 110. The non-volatile storage device 130 stores a configuration database DBp, and a computer program PGp that, when executed by the CPU 110, controls operations of the MFP 100.

The computer program PGp is pre-stored in the non-volatile storage device 130 at the time of manufacturing the MFP 100 in this embodiment. Alternatively, the computer program PGp may be provided in the form of a download from a server connected via the Internet IT or in the form of a storage medium such as a DVD-ROM or a USB flash drive, but is not limited thereto.

The CPU 110 executes the computer program PGp to perform various processes for controlling the operations of the MFP 100. For example, the CPU 110 controls the printing mechanism 170 to print an image. The CPU 110 also controls the reading mechanism 160 to scan an image and generate scanned data representing the scanned image. Furthermore, by executing the computer program PGp, the CPU 110 communicates with the server 300 to perform processes related to the service, such as transmitting history information to the server 300.

The configuration database DBp stores various configuration information related to the MFP 100. The configuration information includes, for example, settings related to printing, settings related to scanning, and settings related to services provided by the server 300.

The reading mechanism 160, under the control of the CPU 110, generates scanned data representing an image of a document by optically reading the document using an image sensor, which may be a one-dimensional image sensor.

The printing mechanism 170, under the control of the CPU 110, executes printing. In this embodiment, the printing mechanism 170 is an inkjet-type printing mechanism that prints an image on a printing medium using multiple types of ink, such as four types of ink: cyan (C), magenta (M), yellow (Y), and black (K). Alternatively, the printing mechanism 170 may be an electrophotographic-type printing mechanism configured to print an image on a printing medium using toner contained in toner cartridges as a colorant.

The MFP 100 is connected to a user's local area network LN and is available for use by the user.

The terminal device 200 is a computing device used by the user of the MFP 100, such as a personal computer, and is also connected to the local area network (LN). The terminal device 200 includes a CPU 210 as a controller, a volatile storage device 220 such as RAM, and a non-volatile storage device 230 such as a hard disk drive or flash memory. In a modification, the terminal device 200 may be a smartphone or a tablet computer, but is not limited thereto.

The terminal device 200 further includes a display unit 240, an operation unit 250 for receiving user operations, and a wired or wireless communication IF 280 for connecting to the Internet IT. The display unit 240 is, for example, a liquid crystal display, and the operation unit 250 includes a touch panel and may also support input from a mouse or a keyboard.

The CPU 210 functions as a processor that performs data processing. The volatile storage device 220 provides a buffer area for temporarily storing various intermediate data generated during processing by the CPU 210. The non-volatile storage device 230 stores a browser program BP.

The CPU 210 executes the browser program BP, which provides web browser functionality on the terminal device 200. With the web browser functionality provided by the browser program BP, the terminal device 200 cooperates with the server 300 to execute a user registration process, as described later. The terminal device 200 is connected to the local area network LN, for example, and accesses the Internet IT via the local area network LN.

The server 300 is a computer operated by a service provider, such as an entity engaged in the manufacturing or sales of the MFP 100, and may be a cloud server. The server 300 includes a CPU 310 as a controller, a volatile storage device 320 such as DRAM, a non-volatile storage device 330 such as a hard disk or flash memory, and a wired or wireless communication IF 380 for connecting to the Internet IT.

The CPU 310 functions as a processor that executes data processing. The volatile storage device 320 provides a buffer area for temporarily storing various intermediate data generated during processing by the CPU 310. The non-volatile storage device 330 stores a computer program PGs and a management database DBs.

The computer program PGs is provided, for example, in the form of an upload by the operator of the server 300. The server 300, by executing the computer program PGs, provides the service. The server 300 also cooperates with the terminal device 200 to execute the user registration process, as described later. The management database DBs stores various types of data necessary for processing related to the service, as will be described later.

The server 300 is connected to the Internet IT, allowing communication with both the MFP 100 and the terminal device 200 via the Internet IT.

In FIG. 1, only the MFP 100 is illustrated as a device connected to the server 300. However, the server 300 is configured to communicate with multiple devices, including MFPs and standalone printers, to provide services utilizing these devices. The following description focuses on processes related to the MFP 100, but the processes may also be executed for other printers that are service targets.

The server 300 provides multiple types of services. These services include various services that utilize the MFP 100, such as a print management service, a remote printing service, a storage service, and a content service.

The print management service manages various aspects of the MFP 100, such as the remaining ink level, print history, and malfunction records. Based on the remaining ink level, the service facilitates ink procurement, and based on the malfunction history, the service supports maintenance operations for the MFP 100.

The remote printing service enables printing using image files stored on the server 300 by a user or image files sent from a user's mobile device (not shown). The service generates a print job using such image files and transmits the job to the MFP 100 for execution.

The storage service stores image files, such as scanned data and print data generated using the MFP 100, on the server 300.

The content service allows the MFP 100 to utilize downloaded content data representing content images. The content images may include font data, fictional characters from animations or comics, and templates for greeting cards (such as New Year's cards or Christmas cards) or calendars, which contain various designs and illustrations.

The following description assumes that the server 300 provides four types of services, referred to as Service 1 through Service 4. In this embodiment, the user is required to complete user registration for each service to utilize the service. During the user registration process for each service, the user and a device, such as the MFP 100, are registered in association with each other. In this embodiment, a single device cannot be associated with multiple user registrations for the same service. For example, if the user has been registered for Service 1 in association with the MFP 100, the user cannot perform another user registration for Service 1 with the same MFP 100. However, the user can be registered for a different service, such as Service 2, using the same MFP 100.

In the following description, user registration is performed by storing user information in association with a device and service(s) utilized by the user in the management database DBs as registration information. A user for whom user information is stored in this manner will be referred to as a registered user. Further, user-related information stored in association with a registered user will be referred to as registered user information.

### A2. Management Database

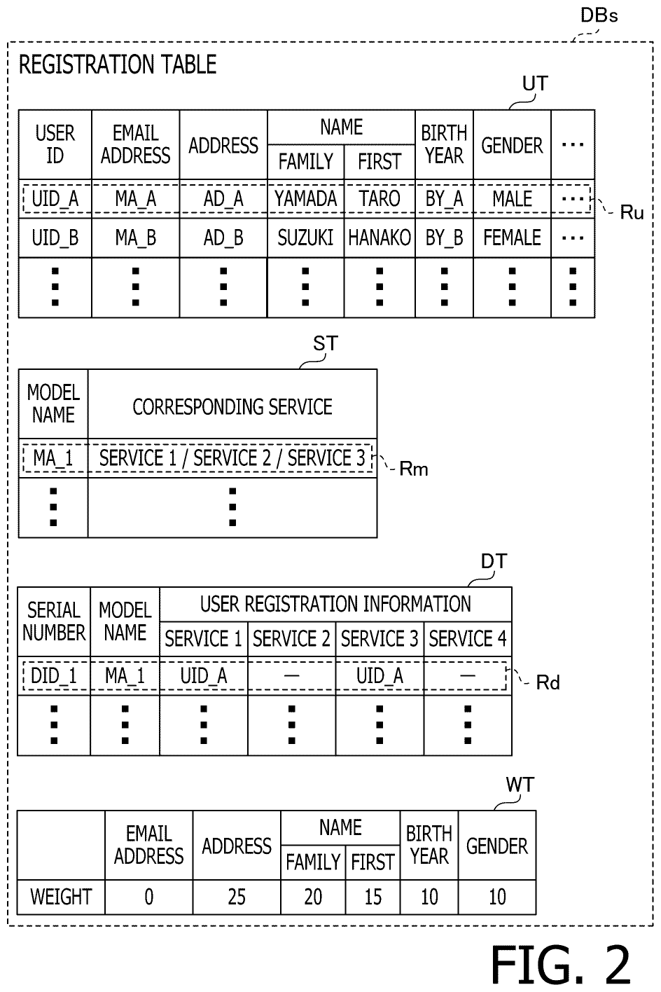

The management database DBs stored in the non-volatile storage device 330 of the server 300 is described below. FIG. 2 schematically illustrates a configuration of the management database DBs. The management database DBs shown in FIG. 2 includes a user table UT, a service association table ST, a device table DT, and a weighting table WT.

The user table UT is a table that stores registered user information for the service. In this embodiment, the user table UT stores user IDs that identify multiple users of the service. Additionally, various types of information associated with each user ID are recorded in the user table UT. As shown in FIG. 2, the user information includes multiple items, specifically a user ID, an email address, an address, a user's name, birth year, and gender. The name field is further divided into separate items for a family name and a first name. The user information also includes payment information (not shown), such as a credit card number, which is necessary for using the service. Accordingly, the user information may contain personal information. In the example shown in FIG. 2, user information in association with user IDs “UID_A” and “UID_B” is recorded.

The service association table ST is a table that records the services available for each device model, referred to as corresponding services. For example, in the case shown in FIG. 2, Service 1, Service 2, and Service 3 are recorded in association with the model name “MA_1.” This indicates that a device with the model name “MA_1” supports Services 1 to 3 among the four available services.

The device table DT is a table that stores information about devices managed by the server 300, such as the MFP 100. In this embodiment, the device table DT stores serial numbers as identification information for multiple devices managed by the server 300. Additionally, the device table DT records, in association with each serial number, a model name and user registration information. The user registration information indicates whether a user has completed registration for services available on the device. If a user is registered, the user registration information further includes details identifying the registered user. Specifically, for each service available on the device, the user registration information associates the corresponding user ID if the user has registered for the service. If the user has not registered, no user ID is associated. Since the serial number is linked to the user ID and is used to identify the device through which the user accesses the service, the serial number is also treated as part of the user information.

In the device table DT shown in FIG. 2, the serial number “DID_1” of the MFP 100 is recorded in association with the model name “MA_1” of the MFP 100 and the user information for each of Services 1 to 4. For Service 1 and Service 3, the user ID “UID_A” is recorded, indicating that a user is registered to use Service 1 and Service 3 with the MFP 100. For Service 2 and Service 4, no user ID is recorded, indicating that no user is registered to use Service 2 or Service 4 with the MFP 100.

The weighting table WT is a table that stores weights used in the user registration process, which will be described later. These weights are assigned to each initial registration item which will be recorded during the user registration process. The initial registration items include, for example, a subset of the user information registered in the user table UT. In this embodiment, the initial registration items include an email address, an address, a user's name (both family name and first name), birth year, and gender. For the user's name, separate weights are assigned to the family name and the first name. Further details regarding the weighting table WT will be provided in the description of the user registration process.

The management database DBs stores various types of information necessary for providing Services 1 to 4. For example, the management database DBs further includes tables for managing the remaining ink levels of devices used in the printing service, such as printers and MFPs. However, since such tables are not directly relevant to the present disclosure, they are omitted from the drawings and description.

### A3. User Registration Process

The user registration processes for Services 1 to 4 will be described below. In each of these services, user registration is performed in association with a device, such as the MFP 100. The user registration process is executed separately for each of Services 1 to 4. The following description provides an example of the user registration process for Service 1.

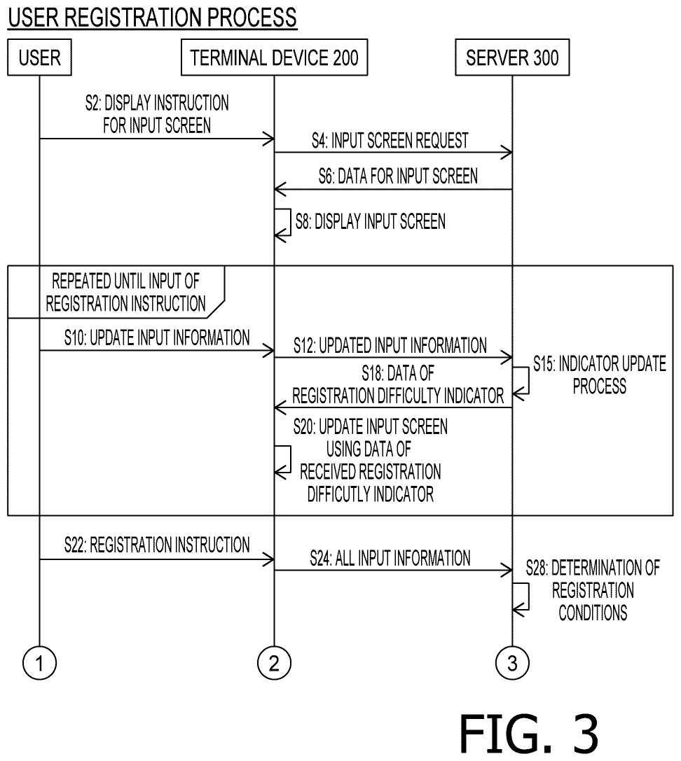

FIGS. 3 and 4 show a sequence diagram illustrating the user registration process for Service 1. In S2, the terminal device 200 obtains a display instruction for an input screen W1 from the user. Specifically, the user launches the browser program BP on the terminal device 200 and performs a particular operation, with the browser program BP providing web browsing functionality. The particular operation includes, for example, entering a Uniform Resource Locator (URL) of the server 300 to access a web page provided by the server 300 and, through this web page, entering the display instruction for the input screen W1.

In response to the terminal device 200 obtaining the display instruction for the input screen W1, the terminal device 200, executing the browser program BP to provide web browsing functionality, transmits an input screen request to the server 300 (S4). Communication between the terminal device 200 and the server 300 is conducted using a known protocol, such as HTTP (Hypertext Transfer Protocol). Accordingly, the input screen request is an HTTP request that includes, for example, a URL indicating the location of the input screen W1 for Service 1.

In response to receiving, through the CPU 310, the input screen request, the server 300 transmits the data for the input screen W1 for Service 1 to the terminal device 200 in S6. Upon receiving the data for the input screen W1, the terminal device 200 displays the input screen W1 on the display unit 240 in S8 using the received data. In other words, the server 300 causes the terminal device 200 to display the input screen W1 on the display unit 240.

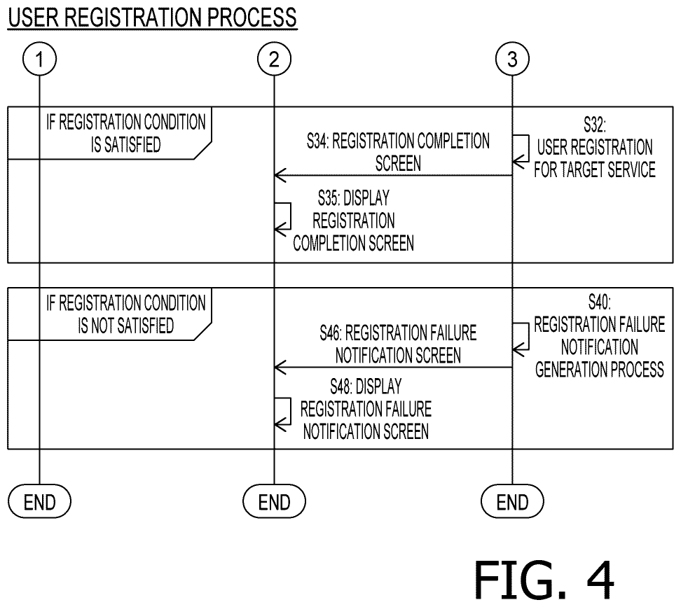

FIG. 5 shows an example of the input screen W1. The input screen W1 shown in FIG. 5 includes a registration prompt message MS1, a registration difficulty indicator RS, and multiple input elements including input fields TB1 to TB6, radio buttons RBa, RBb and RBc, and a registration button BTr.

The registration difficulty indicator RS, which will be described in detail later, is an image that presents information representing the degree of registration difficulty.

The multiple input elements include input fields TB1 to TB5 and radio buttons RBa, RBb and RBc, which are used to enter data for each initial registration item required for the user registration process.

As described above, in this embodiment, the initial registration items include a serial number, an email address, an address, a user's name (family name and first name), a birth year, and a gender. These initial registration items contain personal information about the user as well as information related to the device used for Service 1, such as the MFP 100.

Additional items may also be included as initial registration items. For example, the initial registration items may further include payment information (such as a credit card number), a phone number, a display name, an occupation, or a job title. Furthermore, the initial registration items may include information about the device other than the serial number, such as the purchase date of the device or the store where the device was purchased. The multiple items may include both mandatory input items and optional items. In this embodiment, all initial registration items included in the input screen W1 are mandatory input items.

The registration button BTr is a button that allows the user to enter a registration instruction. From the time the input screen W1 is displayed on the display unit 140 (S8) before the user presses the registration button BTr to enter the registration instruction into the terminal device 200 (S22), the processes in S10 to S20 are repeatedly executed (see FIG. 3).

Before the registration instruction is entered, while the input screen W1 is displayed, each input element in the input screen W1 remains in a state where the user can input corresponding data. This state, in which the user is allowed to provide input using any of the multiple input elements, is referred to as an “input state”.

In S10, the user updates previously input data in one of the input elements on the input screen W1. As a result, the terminal device 200 receives the updated input data for the selected input element.

For example, the user may select an empty input field TB1 and enter an email address. When the user then performs an operation on another input element, such as selecting input field TB2, the terminal device 200 determines that the input data for input field TB1 has been updated and obtains the email address entered in the input field TB1 as the updated input data. Similarly, if the user selects input field TB1, which already contains an email address, and deletes the email address, then performs an operation on another input element, the terminal device 200 obtains data indicating that input field TB1 contains no data as the updated input data. More specifically, the terminal device 200 obtains data indicating that input field TB1 is empty or has returned to its initial state. Additionally, if the user selects input field TB1, which already contains an email address, and replaces the existing email address with another email address, then performs an operation on another input element, the terminal device 200 obtains the newly entered email address as the updated input data.

When the terminal device 200 obtains the updated input data, the terminal device 200 transmits the obtained updated input data to the server 300 in S12. In this manner, each time the input to any one of the input elements is updated, the updated input data is transmitted to the server 300.

When the server 300 receives the updated input data, the server 300 executes an indicator update process in S15 to update the registration difficulty indicator RS.

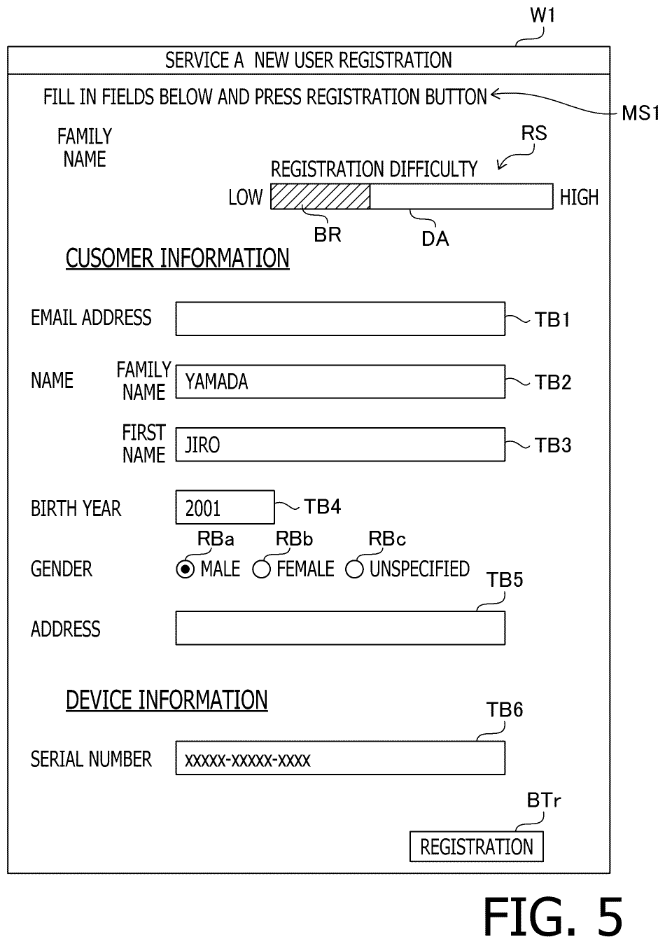

FIG. 6 is a flowchart illustrating the indicator update process. In S110 of FIG. 6, the server 300 updates an input data set for the input screen W1 stored in the server 300 based on the updated input data for one item received in S12. The input data set is a dataset that represents the input data corresponding to respective input elements on the input screen W1 and is used to manage and track user inputs in real time. For example, the input data set stores the input data for all input elements displayed on the input screen W1. The initial values of the input data set indicate that no data has been entered in any input element of the input screen W1. Each time the server 300 receives updated input data for a single item, the input data set is updated accordingly. As a result, the server 300 can track, in real time, the data (such as serial numbers and user information) that has been input via each input element of the input screen W1.

In S115, the server 300 searches the device table DT for a record that includes the serial number entered in the input screen W1. For example, if the serial number entered in the input screen W1 is “DID_1”, the search retrieves record Rd, indicated by a dashed line in FIG. 2. If the input screen W1 contains a serial number that is being registered for the first time or if no serial number has been entered in the input screen W1, no record is retrieved from the search.

In S120, the server 300 determines whether there is a user registration associated with the serial number entered in the input screen W1 based on the search results. Specifically, if a record has been retrieved in S115, the server 300 checks whether the retrieved record includes a user ID that is associated with the service subject to the user registration process (hereinafter referred to as the target service; which is, in this embodiment, Service 1). If the retrieved record includes a user ID that is associated with the target service, the server 300 determines that a user registration exists for the serial number entered in the input screen W1 (S120: YES). On the other hand, if the retrieved record does not include a user ID associated with the target service, the server 300 determines that no user registration exists for the entered serial number (S120: NO). Furthermore, if no record is retrieved in S115, the server 300 also determines that no user registration exists for the entered serial number (S120: NO).

If there is a user registration that is associated with the entered serial number (S120: YES), the server 300 determines a registration difficulty index EV to be the maximum value in S125. The registration difficulty index EV is a value determined based on the current input data for each input element of the input screen W1 (in other words, the updated input data obtained in S12). In this embodiment, the registration difficulty index EV serves as an indicator related to registration difficulty, where a higher value generally suggests a lower likelihood of successful registration. The registration difficulty index EV ranges from 0 to 100, with an initial value of 0. Accordingly, in this step, the registration difficulty index EV is set to 100, which is the maximum value. In other words, the registration difficulty index EV is determined as the value that indicates the lowest registration possibility. After the registration difficulty index EV is determined, the process proceeds to S155. It is noted that the registration difficulty index EV is an example of an index value according to aspects of the present disclosure.

If no user registration is associated with the serial number entered in the input screen W1 (S120: NO), the server 300 performs a search in S130 by comparing the input data from the input screen W1 with the registered user information stored in the user table UT on an item-by-item basis. The server 300 searches for records that contain user information matching at least one item. For example, if the family name entered in the input screen W1 is “Yamada,” the search retrieves record Ru, which is indicated by a dashed line in the user table UT shown in FIG. 2. In this search, multiple records from the user table UT may be retrieved if at least one of their items matches the corresponding input data. Thus, the registration difficulty index EV is determined based on a proximity between the input data from the input screen W1 data and the registered user information stored in the storage device.

In S135, the server 300 determines whether a record of a user already registered for the target service (e.g., Service 1) has been retrieved based on the search results. Specifically, for each user ID included in the one or more records extracted in S130, the server 300 refers to the device table DT to determine whether the user ID is associated with the target service. If at least one of the extracted records in S130 includes a user ID associated with the target service, the server 300 determines that the record of the user already registered for the target service has been retrieved (S135: YES).

On the other hand, if none of the records extracted in S130 contain a user ID associated with the target service, the server 300 determines that no record of a user already registered for the target service has been retrieved (S135: NO). Additionally, if no records are extracted in S130, the server 300 also determines that no record of a user already registered for the target service has been retrieved (S135: NO).

If no record of a user who has already been registered for the target service is retrieved (S135: NO), the server 300 determines the registration difficulty index (EV) to be the minimum value in S140. As described above, the registration difficulty index EV ranges from 0 to 100, with an initial value of 0. Accordingly, in this step, the registration difficulty index EV is set to 0, which is the minimum value. In other words, in this step, the registration difficulty index EV is determined to be the value indicating the highest registration possibility. After the registration difficulty index EV is determined, the process proceeds to S155.

If a record of a user who has already been registered for the target service is retrieved (S135: YES), the server 300 calculates a sum WA of weights of the matching items for each retrieved registered user record in S145. Specifically, for a selected record among the retrieved registered user records, the server 300 identifies one or more input elements (hereinafter referred to as matching items) where the input data entered in the input screen W1 matches the information recorded in the retrieved record. The server 300 then obtains the weights assigned to the matching items from the weighting table WT (FIG. 2) and calculates the sum of these weights as the sum WA of weights of matching items for the selected record.

For example, if “address” and “family name” are identified as matching items, and the weight assigned to “address” is 10 while the weight assigned to “family name” is also 10, the sum WA of weights of matching items is calculated as 10+10=20. By summing the weights of matching items in this manner, the sum WA of weights of matching items is obtained as a candidate for the registration difficulty index (EV).

In S150, the server 300 determines the registration difficulty index (EV) as the maximum value among the sums WA of weights of matching items of the retrieved registered user records.

As described above, the registration difficulty index (EV) is determined based on a comparison between the multiple pieces of input data entered in the input screen W1 and the user information registered in the management database DBs. In other words, the registration difficulty index EV corresponds to the proximity between the multiple pieces of input data entered in the input screen W1 and the user information registered in the management database DBs.

Here, additional details regarding the weights recorded in the weighting table WT shown in FIG. 2 are provided.

In the weighting table WT, the weight assigned to an email address is set to “0”. This means that whether the email address entered in the input screen W1 matches the email address contained in the registered user information does not affect the sum WA of weights of matching items, and consequently, does not influence the registration difficulty index (EV).

If the registration difficulty index EV were to fluctuate based on whether the entered email address matches a registered email address, the registration difficulty indicator RS would also change accordingly. In such a case, an unauthorized party could input various email addresses into the input field TB1 and observe the changes in the registration difficulty indicator RS. By doing so, the unauthorized party might be able to determine whether an entered email address is already registered. This could allow the unauthorized party to obtain registered users' email addresses illicitly. Since email addresses can be easily misused, such as for spam distribution, their leakage could cause significant harm. For this reason, in this embodiment, the weight assigned to email addresses is set to “0” to prevent such exploitation.

Additionally, in the weighting table WT, the weights assigned to birth year and gender are lower than those assigned to address and name. This is because birth year and gender have a weaker relationship with the registration conditions, which will be described later.

In S155 of FIG. 6, the server 300 generates the registration difficulty indicator RS based on the determined registration difficulty index EV. Once the registration difficulty indicator RS is generated, the server 300 completes the indicator update process.

As shown in FIG. 5, the registration difficulty indicator RS includes a bar-shaped display area DA and a bar-shaped section BR (hatched area) positioned within the display area DA. The length of the bar-shaped section BR in the longitudinal direction (horizontal direction in FIG. 5) corresponds to the registration difficulty index EV. Accordingly, in this embodiment, the longer the bar-shaped section BR extends in the horizontal direction, the lower the registration possibility, and the shorter the bar-shaped section BR is, the higher the registration possibility. The length of the bar-shaped section BR in the longitudinal direction may be determined in three to five discrete stages. In this embodiment, when the registration difficulty index EV is 0 or more but less than 35, the length of the bar-shaped section BR is set to one-third of the display area DA. When the registration difficulty index EV is 35 or more but less than 70, the length of the bar-shaped section BR is set to two-thirds of the display area DA. When the registration difficulty index EV is 70 or more, the length of the bar-shaped section BR is set equal to the display area DA.

In S18 of FIG. 3, the server 300 transmits the data of the registration difficulty indicator RS, which was generated in the indicator update process (S15), to the terminal device 200. Upon receiving the registration difficulty indicator RS data, the terminal device 200 updates the input screen W1 displayed on the display unit 240 in S20 using the received data. Specifically, the terminal device 200 updates the registration difficulty indicator RS included in the input screen W1 with the registration difficulty indicator RS indicated by the data received in S18.

The processes S10 to S20 described above are repeated each time data is entered into any one of the input elements of the input screen W1. As a result, during the process in which the user enters data into the input screen W1, the registration difficulty indicator RS is continuously updated in real-time.

When the user completes input on the input screen W1, the user enters a registration instruction by pressing the registration button BTr in S22. In S22, the registration instruction is entered while the data corresponding to multiple items, which should be input into the input elements TB1 to TB6, and one of RBa, RBb or RBc of the input screen W1, has already been entered into these input elements. When the terminal device 200 acquires the registration instruction from the user, it retrieves all input data entered in the input elements TB1 to TB6, and one of RBa, RBb or RBc at that moment and transmits the entire set of input data to the server 300.

When the server 300 receives the input data from the terminal device 200, the server 300 determines in S28 whether the registration conditions are satisfied based on the multiple items of information entered by the user into the input screen W1.

In this embodiment, the registration conditions are determined to be satisfied when the following three conditions are met. If at least one of these conditions is not met, the registration conditions are determined to be not satisfied.

Condition 1: The entered serial number does not match any serial number of a registered device used for the target service.
Condition 2: The entered email address does not match an email address of any registered user for the target service.
Condition 3: The combination of the entered address and name (family name and given name) does not match the combination of address and name of any registered user for the target service.

As evident from the three conditions described above, in this embodiment, the registration conditions include a requirement that the data of at least part of the multiple input items entered in the input screen W1 does not match at least part of the multiple items contained in the registered user information.

If no record containing the serial number included in the input data obtained through the input screen W1 is recorded in the device table DT, or if a record containing the serial number is recorded in the device table DT but does not include a user ID for the target service, then Condition 1 is determined to be satisfied.

If the email address included in the input data obtained through the input screen W1 is not recorded in the user table UT as an email address of a registered user for the target service, then Condition 2 is determined to be satisfied.

If the combination of the address and name included in the input data for the input screen W1 is not recorded in the user table UT as the address and name of a registered user for the target service, then Condition 3 is determined to be satisfied.

As evident from the above explanation, the registration conditions in this embodiment are determined based on a comparison between the multiple items of information entered in the input screen W1 and the multiple items of information registered in the management database DBs, including the user table UT and the device table DT.

If the registration conditions are determined to be satisfied in S28 (FIG. 3), the processes in S32 to S35 of FIG. 4 are executed.

In S32, the server 300 performs user registration for the target service using data corresponding to the multiple items received from the terminal device 200. Specifically, the server 300 generates a user ID and records the received user information, such as email address, address, and name, in the user table UT while associating it with the generated user ID. As a result, a new record is added to one row of the user table UT, as shown in FIG. 2.

Furthermore, the server 300 registers a new user associated with the device (e.g., the MFP) 100 for the target service (e.g., Service 1). Specifically, the server 300 identifies the model name of the MFP 100 by searching for the serial number received in S28 within a table (not shown) that associates serial numbers with model information. The server 300 then records the user ID indicating the user of Service 1 in the device table DT, associating the user ID with the serial number and model name of the MFP 100. The recorded user ID corresponds to the newly registered user ID in the user table UT. As a result, a new record is added as one row of the device table DT in FIG. 2.

In S34, the server 300 causes the terminal device 200 to display the registration completion screen W2. Specifically, the server 300 transmits the data of the registration completion screen W2 to the terminal device 200. Upon receiving the data of the registration completion screen W2, the terminal device 200 displays the registration completion screen W2 on the display unit 140 in S35 using the received data.

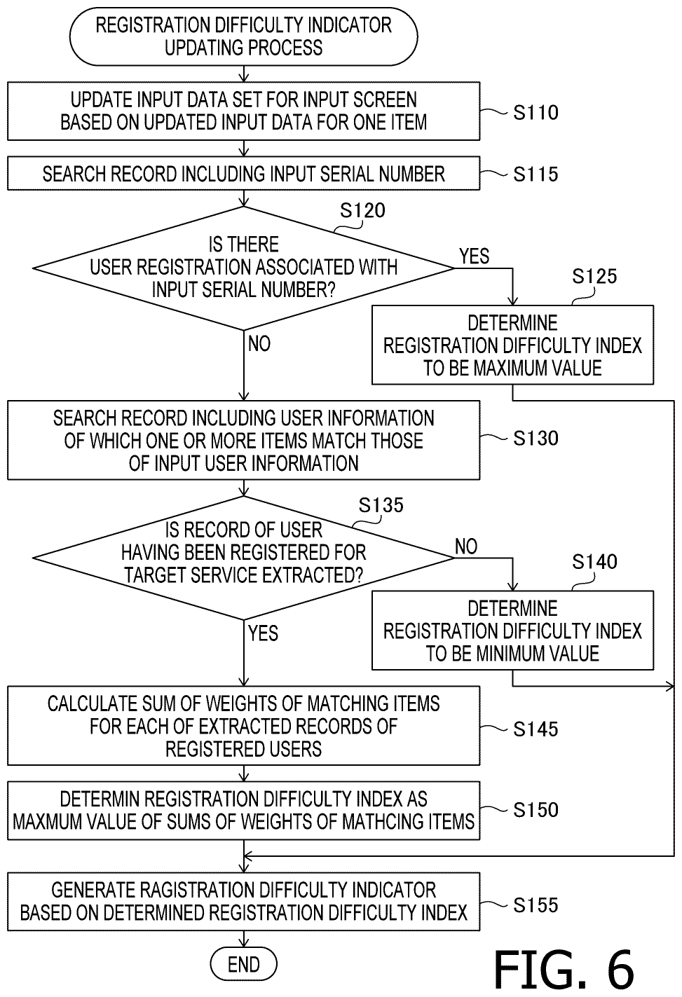

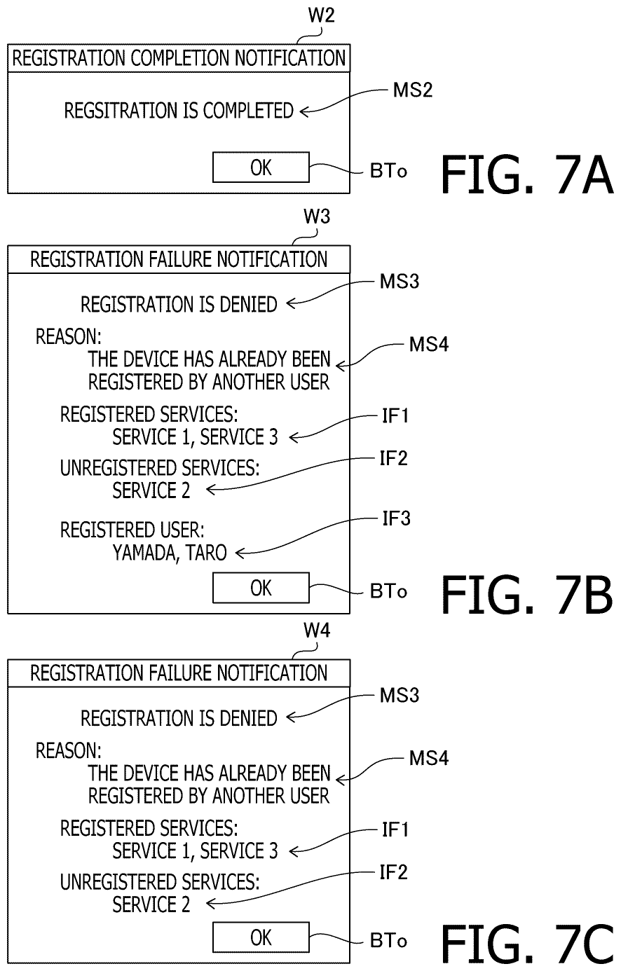

FIGS. 7A-7C illustrate an example of a registration completion screen and examples of a registration failure notification screen, respectively. The registration completion screen W2 shown in FIG. 7A includes a message MS2, which indicates that user registration for the target service has been successfully completed, and an OK button BTo. When the OK button BTo is pressed, the terminal device 200 closes the registration completion screen W2, and the user registration process is completed.

Once the user registration process is completed, the user can utilize Service 1 with the MFP 100. For example, if Service 1 is the print management service described earlier, the MFP 100 receives periodic transmission setting information from the server 300 and stores the received information in the configuration database DBp. Thereafter, the MFP 100 periodically uploads information such as ink remaining levels, print history, and failure history to the server 300 in accordance with the periodic transmission setting information. Based on the uploaded information, the server 300 performs operations such as arranging ink supply and processing billing transactions.

If the registration conditions are determined not to be satisfied in S28, the processes in S40 to S48 of FIG. 4 are executed. In S40, the server 300 performs a registration failure notification generation process, which generates a registration failure notification screen to inform the user that registration for the target service cannot be completed.

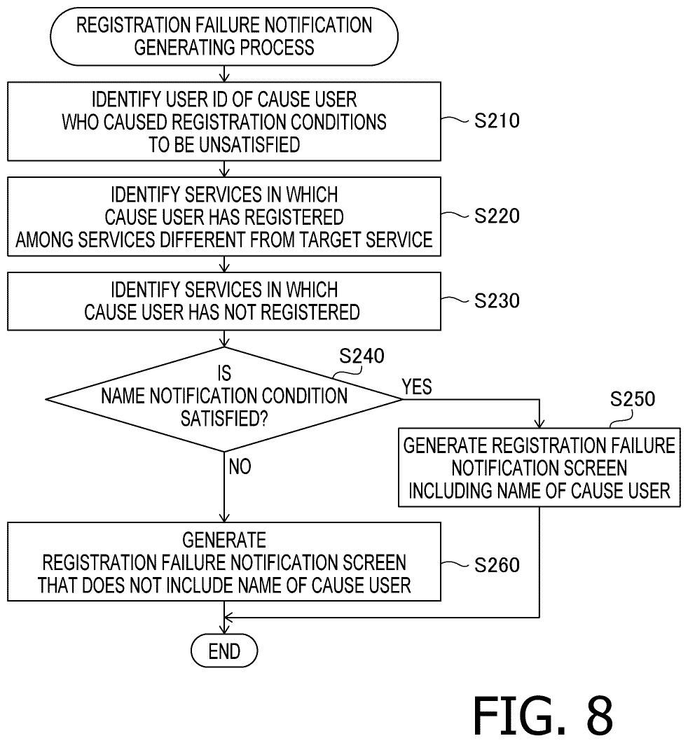

FIG. 8 is a flowchart illustrating the registration failure notification generation process.

In S210, the server 300 (i.e., the CPU 310) identifies the user ID of a registered user that caused the registration conditions to be unsatisfied (hereinafter referred to as a cause user). In other words, when specific user information (e.g., a serial number or an email address) is already registered in the management database DBs, including the user table UT and the device table DT, and as a result, the registration conditions are not satisfied, the user ID included in the registered user information (i.e., the cause user's user information) is identified.

For example, when the registration conditions are not satisfied due to Condition 1 not being met, the cause user's user ID is identified from the record in the device table DT that contains the same serial number as the entered serial number and is associated with the target service. If the entered serial number is “DID_1” and the target service is “Service 1”, the user ID “UID_A” associated with Service 1 in the record Rd shown with a dashed line in FIG. 2 is identified as the cause user's user ID.

Similarly, when the registration conditions are not satisfied due to Condition 2 not being met, the cause user's user ID is identified from the record in the user table UT that contains the same email address as the entered email address. If the entered email address is “MA_A”, the user ID “UID_A” included in the record Ru shown with a dashed line in FIG. 2 is identified as the cause user's user ID.

Likewise, when the registration conditions are not satisfied due to Condition 3 not being met, the cause user's user ID is identified from the record in the user table UT that contains the same combination of address and name as the entered address and name.

In S220, the server 300 identifies a service different from the target service in which the cause user is already registered. For example, the server 300 searches the device table DT to locate the record that includes the cause user's user ID. The server 300 then examines the service registration information in the identified record to determine which services are associated with the cause user's user ID, excluding the target service.

For example, if the cause user's user ID is “UID_A” and the target service is “Service 1”, the record Rd, shown with a dashed line in FIG. 2, is identified in the device table DT. In the service registration information of record Rd, “UID_A” is associated with both Service 1 and Service 3. Therefore, in this case, Service 3 is identified as a service in which the cause user is already registered. If the cause user is not registered for any other services, the server 300 determines that no other services are registered for the cause user.

The service identified in this step is a service different from the target service that the user currently undergoing the user registration process cannot register for using the entered user information.

In S230, the server 300 identifies a service for which the cause user has not yet been registered among the services available using the device with the entered serial number. To achieve this, the server 300 searches a table (not shown) that associates serial numbers with model information to identify the model name of the MFP 100 based on the entered serial number. Then, by searching the service association table ST in FIG. 2 for a record that contains the identified model name, the server 300 determines which services are available using the MFP 100.

Next, the server 300 refers to the service registration information in the device table DT, specifically in the record containing the cause user's user ID, to identify which available services do not have a user ID associated with them.

For example, if the model name of the MFP 100 is “MA_1”, the record Rm, shown with a dashed line in FIG. 2, is referenced, and the available services for the MFP 100 are determined to be Service 1 to Service 3. If the cause user's user ID is “UID_A”, then by referring to the record Rd in FIG. 2, it is determined that Service 2 and Service 4 do not have a user ID associated with them. Therefore, in this example, Service 2 is identified as a service that the cause user has not yet registered for. If there are no services which the cause user has not yet been registered for, the server 300 determines that no unregistered services exist for the cause user.

The service identified in S230 is one of the services available using the MFP 100, for which the user currently undergoing the user registration process can be registered using the entered user information.

In S240, the server 300 determines whether a name notification condition is satisfied. The name notification condition is used to decide whether the cause user's name should be notified to the user currently undergoing the user registration process. If the name notification condition is satisfied, the cause user's name is included in the notification. In this embodiment, the name notification condition is determined to be satisfied if the address and family name entered in the input screen W1 match the address and family name of the cause user. Since the cause user's address and family name are registered in the user table UT, the server 300 determines whether the condition is satisfied by referring to the user table UT.

If the name notification condition is satisfied (S240: YES), the server 300 generates a registration failure notification screen W3 in S250, which includes the cause user's name. Once the registration failure notification screen W3 is generated, the registration failure notification generation process is completed.

The registration failure notification screen W3, shown in FIG. 7B, includes a message MS3 indicating that user registration for the target service cannot be completed (i.e., denied), a message MS4 explaining the reason for the registration failure, registered service information IF1, unregistered service information IF2, name information IF3 indicating the cause user's name, and an OK button BTo.

If user registration cannot be completed due to Condition 1 not being met, the message MS4 indicates that the user's device (e.g., the MFP 100) has already been registered as a device for Service 1.

If user registration cannot be completed due to Condition 2 not being met, the message MS4 indicates that the email address entered by the user has already been registered as the email address of another user registered for Service 1. If user registration cannot be completed due to Condition 3 not being met, the message MS4 indicates that the combination of the address and name entered by the user has already been registered as the address and name of another user registered for Service 1.

The registered service information IF1 indicates the services for which the cause user has already been registered. If the cause user has no other registered services, the registered service information IF1 is not displayed. The unregistered service information IF2 indicates the services for which the cause user has not been registered. If there are no unregistered services for the cause user, the unregistered service information IF2 is not displayed.

If the name notification condition is not satisfied (S240: NO), the server 300 generates a registration failure notification screen W4 in S260, which does not include the cause user's name. Once the registration failure notification screen W4 is generated, the registration failure notification generation process is completed. The registration failure notification screen W4, shown in FIG. 7C, includes a message MS3 indicating that user registration for the target service cannot be completed, a message MS4 explaining the reason for the registration failure, registered service information IF1, unregistered service information IF2, and an OK button BTo. Unlike the registration failure notification screen W3, the registration failure notification screen W4 does not include name information IF3.

In S46 of FIG. 4, following the registration failure notification generation process, the server 300 transmits the data of the registration failure notification screen W3 or W4 to the terminal device 200. When the terminal device 200 receives the data of registration failure notification screen, the terminal device 200 updates the display unit 240 to show the registration failure notification screen in S48.

By viewing the registration failure notification screen W3 or W4, the user can recognize that registration for the target service has been denied and understand the reason for the denial. Additionally, by viewing the registration failure notification screen W3 or W4, the user can identify both the other services that cannot be registered and the services that are available for registration using the MFP 100. Furthermore, by viewing the registration failure notification screen W3, the user can recognize the name of the registered user who caused the registration to be denied.

According to the embodiment described above, the system 1000 displays the input screen W1 (see FIG. 5) on the display unit 240 of the terminal device 200 (S2 to S8 in FIG. 3). When a registration instruction is entered while multiple input elements TB1 to TB6, and one of RBa, RBb or RBc contain input data (S22 in FIG. 3), the system 1000 determines whether the entered input data satisfies the registration conditions (S28 in FIG. 3).

If the registration conditions are satisfied, the system 1000 registers the user information, including the entered input data, by storing it in the management database DBs (the user table UT and the device table DT in FIG. 2) (S32 in FIG. 4). If the registration conditions are not satisfied, the system 1000 does not perform user registration (S40 to S48 in FIG. 4).

Before a registration instruction is entered, while the input screen W1 is displayed, the system 1000 obtains the entered input data for multiple input elements during the input state (S12 in FIG. 3). Based on the input data obtained during the input state, the system 1000 determines the registration difficulty index (EV) (S15 in FIGS. 3, S110 to S150 in FIG. 6).

During the input state, the system 1000 displays the registration difficulty indicator RS on the input screen W1 currently shown on the display unit 240. This image serves as suitability information based on the registration difficulty index (EV) (FIGS. 5, S18 and S20 in FIG. 3).

When a registration instruction is entered after multiple items of information have been input into the input screen W1, and user registration is not performed because the registration conditions are not satisfied, the user may experience frustration. In such a case, for example, if the number of required input items is large, the user may feel dissatisfied that the input effort was wasted. Additionally, if the required input items include personal information, the user may be particularly frustrated by the fact that personal data was transmitted but not registered.

In this embodiment, during the input state, the registration difficulty index (EV) is determined based on the information entered through the input screen W1, indicating the likelihood of user registration being permitted. Furthermore, the registration difficulty indicator RS, which serves as suitability information based on the registration difficulty index (EV), is displayed on the input screen W1 (FIG. 2).

As a result, while entering information into the input screen W1, the user can gain some awareness of whether user registration is likely to be permitted. Accordingly, the user may choose to abandon the registration process midway instead of proceeding with input. Additionally, even if user registration is ultimately not performed after the user enters all required information and submits a registration instruction, the user can anticipate this outcome in advance, reducing the likelihood of frustration. Thus, when requesting users to input data into the input screen for user registration, this approach mitigates potential user dissatisfaction.

According to this embodiment, during the input state, each time input to one of the multiple input elements TB1 to TB6, RBa, RBb and RBc is completed, the system 1000 obtains the input data (S12 in FIG. 3), updates the registration difficulty index EV based on the obtained input data (S15 in FIG. 3), and updates the registration difficulty indicator RS displayed on the input screen W1 based on the updated registration difficulty index (S18 and S20 in FIG. 3). As a result, each time input of an input element is completed, the registration difficulty indicator RS displayed on the input screen W1 is updated. Consequently, the user can continuously assess, in real time, the likelihood of user registration being permitted each time information is entered for an input element.

As can be understood from the description on the weighting table WT in FIG. 2, the indicator update process in FIG. 6, and the registration conditions (Conditions 1 to 3), the registration difficulty index (EV) does not precisely correspond to the probability of satisfying the registration conditions. For example, if the set of address and name (family name and given name) entered in the input screen W1 matches the set of address and name of a user already registered for the target service, the registration conditions are not satisfied. However, this does not necessarily mean that the registration difficulty index reaches its maximum value.

Furthermore, when the existence of an already registered user prevents the user currently entering information into the input screen W1 from completing the user registration, there are cases where the user has previously registered but has forgotten, or where a cohabiting family member has already completed the registration. In such cases, if the user gradually sees an increase in the registration difficulty index (EV) displayed in the registration difficulty indicator RS while entering information into the input screen W1, the user may anticipate the possibility of being unable to complete the registration. Consequently, even if the user ultimately fails to register after entering a large amount of information, the dissatisfaction experienced by the user can be mitigated. Additionally, if the user decides to discontinue the registration process based on the suggestion, it is expected that frustration associated with the process can be avoided.

Furthermore, in this embodiment, the registration difficulty index EV is determined by comparing the entered input data with the registered user information on an item-by-item basis and adding a specific value (in this embodiment, a weight) for each matching item (S145 in FIG. 6). As shown in Conditions 1 to 3, if certain items in the input data entered through the input screen W1 match corresponding items in the registered user information, the registration conditions are not satisfied. Therefore, in this embodiment, by determining the registration difficulty index EV using a method in which a specific value is added for each matching item, an appropriate registration difficulty index EV can be determined.

Furthermore, in this embodiment, the registration difficulty index EV is determined using the weights respectively assigned to the multiple items to be entered (weighting table WT in FIG. 2). The multiple items to be entered include those that are more or less relevant to the registration conditions. Additionally, for certain items, it may be preferable that they do not affect the registration difficulty index EV. Therefore, by assigning weights to each of the multiple items, an appropriate registration difficulty index EV can be determined using these weights.

According to the present embodiment, the multiple items of user information include a serial number that identifies the device used by the user. In the present embodiment, when the serial number entered through the input screen W1 matches already registered serial identification information (YES in S120 of FIG. 6), the registration difficulty index EV is set to its maximum value, indicating the lowest registration possibility (S125 of FIG. 6). As a result, if the user attempts to redundantly register a device that has already been registered for the service by entering an already registered serial number in the input field TB6, the registration difficulty indicator RS displayed on the input screen W1 at that moment will indicate the lowest registration suitability. This prevents the user from attempting to redundantly register a device that is already registered for the service.

For example, in this embodiment, if the user attempts to redundantly register a device that has already been registered for the service, registration will not be allowed regardless of the information entered for other user details. In such cases, entering user information, including personal information, into the input screen W1 would be futile. Therefore, it is desirable to prominently indicate that registration is not possible. In this embodiment, the system can display a registration difficulty indicator RS that prominently indicates the inability to register in such cases.

Furthermore, according to the present embodiment, when user registration for Service 1 is not performed during the user registration process for Service 1, other services among Services 1 to 4 that are associated with the user information of the cause user, whose information led to the failure to satisfy the registration conditions, are displayed on the display unit 240 (S220 of FIG. 8, FIGS. 7B and 7C). These other services refer to services for which the cause user is already registered. As a result, when user registration for Service 1 is not possible, the server 300 notifies the user of other services for which registration is not possible.

Furthermore, according to the present embodiment, when user registration for Service 1 is not performed during the registration process for Service 1, services among Services 1 to 4 that are not associated with the user information of the cause user (specifically, services for which the cause user is not yet registered) are displayed on the display unit 240 (S230 of FIG. 8, FIGS. 7B and 7C). As a result, when user registration for Service 1 is not possible, the server 300 notifies the user of services for which registration is possible.

Thus, in the present embodiment, during the user registration process for Service 1, the user can also determine whether registration is possible for other services, such as Service 2to Service 4, which enhances convenience.

Furthermore, in the present embodiment, when the address and the family name entered through the input screen W1 match the address and family name included in a specific registered user's information, and user registration is not performed due to the existence of that registered user, the given name included in the specific registered user's information is displayed on the display unit 240 (YES in S240 of FIG. 8, S250, FIG. 7B). In other words, when the address and family name of the registered user match the address and family name entered through the input screen W1, the given name of the registered user is notified to the user performing the registration process. If the address and family name of the registered user match those entered through the input screen W1, it is likely that the registered user is a family member living with the user performing the registration process. In such cases, the inability to complete user registration is likely due to the prior registration of the family member. Therefore, notifying the user performing the registration process that a family member has already registered is appeared to be appropriate. As a result, for example, the user can recognize that individual registration is unnecessary and that the service can be used together with the registered family member.

Furthermore, in the present embodiment, the weight assigned to the email address in the weighting table WT is set to “0” (FIG. 2). That is, in the present embodiment, the registration difficulty index EV is determined independently of whether the email address entered through the input screen W1 matches an email address included in the registered user information. As a result, regardless of the email address entered in the input field TB1 of the input screen W1, the registration difficulty indicator RS remains unchanged. Consequently, this prevents the leakage of registered email addresses through unauthorized probing attempts.

The serial number in the present embodiment is an example of device identification information, and the user information of the cause user is an example of specific user information according to aspects of the present disclosure. Further, the MFP 100 in the present embodiment is an example of a device, the non-volatile storage device 330 storing the management database DBs is an example of a storage device, and the email address is an example of a specific item according to aspects of the present disclosure. The registration difficulty index EV is an example of an index value according to aspects of the present disclosure. The registration difficulty indicator RS is an example of an indicator according to aspects of the present disclosure.

### B. Modifications

While aspects of the present disclosure have been described in conjunction with various example structures outlined above and illustrated in the figures, various alternatives, modifications, variations, improvements, and substantial equivalents, whether known or presently unforeseen, may become apparent to those having at least ordinary skill in the art. Accordingly, the example embodiments set forth above are intended to be illustrative and not limiting. Various changes may be made without departing from the spirit and scope of the present disclosure. Therefore, the present disclosure is intended to embrace all known or later developed alternatives, modifications, variations, improvements, and substantial equivalents. Some specific examples of potential alternatives, modifications, or variations are provided below.

(1) In the user registration process of the above-described embodiment, the registration condition is that the serial number, email address, or the combination of address and family name entered through the input screen W1 does not match the information included in the registered user information. In an alternative approach, for example, user registration may first be performed by registering user information, including a device serial number, independently of the service, and subsequently, a registered user account may be used to apply for service registration separately. In this case, the registration condition for service registration may be that the user information entered through the input screen, such as the serial number, matches the information included in the registered user information. In such an approach, the registration difficulty index may be determined such that as the number of matching items between the entered information and the registered user information increases, the registration suitability increases.

(2) In the user registration process of the above-described embodiment, the registration difficulty index EV increases as the registration possibility decreases. Accordingly, in S145 of the above-described embodiment, the sum WA of weights, which serves as a candidate value for the registration difficulty index EV, is calculated by adding the weights assigned to each matching item. Instead of this approach, for example, the index EV may be defined as a registration difficulty index EV that may be determined such that a higher value indicates higher registration possibility. In such a case, in S145 of the above-described embodiment, the candidate value for the index EV may be calculated by subtracting the weight assigned to each matching item from an initial value (e.g., 100).

(3) In the above-described embodiment, the registration difficulty index EV is calculated while excluding the email address by assigning it a weight of “0.” Instead of this approach, the system may simply omit processing related to the email address when calculating the registration difficulty index EV. For example, the system may skip the determination of whether the entered email address matches a registered email address.

Furthermore, the items excluded from the calculation of the registration difficulty index EV are not limited to email addresses. Other items among the multiple pieces of information entered in the input screen W1, such as an address, may also be excluded from the calculation of the registration difficulty index EV. Additionally, if the input screen W1 includes a field for a mobile phone number, the mobile phone number may also be excluded from the calculation. In general, personal information that is expected to be unique for each user, such as an email address or a mobile phone number, may be excluded from the calculation of the registration difficulty index EV.

Furthermore, in another example, the weight assigned to an email address may be set to a value other than “0”, such as “35”, when certain conditions are met, such as when both an address and an email address are matching items or when the sum WA of weights reaches “25” or higher, which suggests that the input user is unlikely to be an unauthorized individual. The value “35” is an example selected so that, in the case where the registration difficulty indicator RS is displayed in three stages, the possibility of registration being denied is raised by one level.

Alternatively, the weight assigned to an email address may be added only when weights are also added due to matching items other than the email address. In this case, when the sum WA of weights resulting from the matching of items other than the email address is “0”, the weight for the email address is not added. However, if there are other matching items, the weight for the email address is added together with the weights of the other matching items. This approach prevents an unauthorized individual from determining whether the most recently entered item is a matching item, thereby making it more difficult to fraudulently obtain registered email addresses. More generally, for security reasons, rather than calculating the sum WA of weights immediately after the completion of an input for each item, the calculation may be delayed to prevent an unauthorized individual from identifying matching items.

(4) In the above-described embodiment, the registration difficulty indicator RS represents the registration difficulty index EV by the length of the bar-shaped section BR. However, the form of the registration difficulty indicator RS is not limited to this approach and may take various forms. For example, the registration difficulty indicator RS may be an image displaying a numerical value corresponding to the registration difficulty index EV, a text-based image describing the degree of registration suitability in words, or an image indicating the registration difficulty index EV through the number of symbols such as stars or circles. Furthermore, the registration difficulty indicator RS may represent the registration difficulty index EV using colors. For instance, the registration difficulty indicator RS may be displayed in red when the likelihood of registration failure is high, yellow when it is moderate, and blue when the likelihood of registration failure is low.

(5) The registration conditions (Conditions 1 to 3) described in the above embodiment are merely examples and are not limited to these. For instance, if a single device is allowed to be registered by multiple users for a particular service, Condition 1 may be omitted. In this case, when calculating the registration difficulty index EV, the serial number of the device may be disregarded. Alternatively, instead of Conditions 2 and 3, the registration condition may include a requirement that at least one piece of information among the multiple input items entered into the input screen W1, excluding the serial number of the device, differs from the registered user information (i.e., is not a complete match).

(6) In the above embodiment, each time input is completed for a single input element in the input screen W1, the processes S12 to S20 in FIG. 3 are repeated. Alternatively, instead of this approach, the processes S12 to S20 in FIG. 3 may be repeated at predetermined time intervals (e.g., every 10 seconds) during the input state, thereby updating the registration difficulty indicator RS at regular intervals.

(7) In the above embodiment, the registration difficulty index EV is determined using the weights assigned to each of the multiple items entered in the input screen W1. However, the determination of the registration difficulty index EV is not limited to the use of weights. Instead, the registration difficulty index EV may be determined based on the number of items among the multiple items for which the information entered in the input screen W1 matches the registered information, without using weights.

(8) In the above embodiment, when the name notification condition is satisfied, the registration failure notification screen W3 shown in FIG. 7B includes the display IF3 of the name of the cause user, whose registration prevents the registration condition from being met. Alternatively, the registration failure notification screen W3 may display only the given name of the cause user, excluding the family name. Furthermore, the display of the cause user's name may be omitted entirely, and instead, the registration failure notification screen W4 shown in FIG. 7C may always be displayed when presenting a registration failure notification.

(9) In the above embodiment, the registration failure notification screens W3 and W4 include the registered service information IF1 and the unregistered service information IF2, as shown in FIGS. 7B and 7C. Alternatively, the registration failure notification screens W3 and W4 may include only one of the registered service information IF1 or the unregistered service information IF2, or may exclude both.

(10) In the above embodiment, the server 300 provides Services 1 to 4. Alternatively, a server separate from the server 300 may provide Services 1 to 4, and the server 300 may function solely as a server that manages user registration for the services.

(11) In the above embodiment, the user registration process is implemented by a single server 300. Alternatively, the initial registration process and subsequent registration process may be implemented by distributing roles among two or more servers that are capable of communicating with each other. For example, a first server that communicates with the terminal device 200 and provides various screens W1 to W4 to the terminal device 200, and a second server that manages registration information such as the user table UT and the device table DT, may cooperate to implement the user registration process.

(12) In the above embodiment, a part of the configuration implemented by hardware may be replaced with software. Conversely, a part or all of the configuration implemented by software may be replaced with hardware.

What is claimed is:

1. A communication system, comprising:
a terminal device including a display unit configured to display an image, and an operation unit configured to receive user operations; and
a server including a storage device configured to store user information of registered users, the user information including data corresponding to multiple input items,
wherein the system is configured to perform:
causing the display unit of the terminal device to display an input screen including multiple input elements, each configured to receive data corresponding to one of the multiple input items;
during an input state in which the input screen is displayed to allow data input to each of the multiple input elements before a registration instruction is received, obtaining data having been input into at least one of the multiple input elements;
determining, during the input state, an index value based on a proximity between the obtained data and the registered user information stored in the storage device;
causing, during the input state, the display unit to display an indicator, which is a visualization based on the index value, on the input screen being displayed on the display unit;
in response to receiving a registration instruction in association with the data corresponding to the multiple input items having been input to the multiple input elements, determining whether a registration condition is satisfied based on a comparison between the received data corresponding to the multiple input items and the data corresponding to the multiple input items included in the user information stored in the storage device; and
completing user registration by storing the user information, including the received data corresponding to the multiple input items, into the storage device as user information for a newly registered user when the registration condition is determined to be satisfied, wherein the user registration is not completed when the registration condition is determined not to be satisfied.

2. The communication system according to claim 1,
wherein, during the input state, in response to data having been input into any one of the multiple input elements, the communication system performs:
obtaining input data corresponding to any one of the multiple input items;
updating the index value using the input data corresponding to any one of the multiple input items; and
causing, during the input state, the display unit to display an updated indicator based on the updated index value.

3. The communication system according to claim 1,
wherein the index value is determined by:
comparing, on an item-by-item basis, at least one piece of input data with corresponding data in the registered user information, and
adjusting the index value by adding or subtracting a specified value for each matching item.

4. The communication system according to claim 3,
wherein the server determines the index value using weights assigned to the respective input items.

5. The communication system according to claim 3,
wherein the user registration is performed for services that require the device,
wherein the multiple items include device identification information identifying the device,
wherein the server determines that the index value is lowest when the device identification information having been input matches the device identification information associated with the registered user information.

6. The communication system according to claim 3,
wherein user registration is performed for each of multiple services provided via a device,
wherein:
the registered user information is stored in association with the service for which the user registration is performed;
the registration condition for each of the multiple services requires that at least some entered information does not match the registered user information; and
when user registration for a specific service is denied due to partial matching with existing registered user information, the communication system displays, on the display unit, other services associated with the registered user information.

7. The communication system according to claim 3,
wherein user registration is performed for each of a plurality of services provided via a device,
wherein the registered user information is stored in association with the target service among the plurality of services,
wherein the registration condition requires that at least some of the entered information does not match the registered user information, and
wherein, when user registration for a specific service is denied due to partial matching with specific registered user information,
the communication system displays, on the display unit, services not associated with the specific registered user information.

8. The communication system according to claim 3,
wherein the multiple input items include user address and user name, and
wherein, when the entered address and the family name of the entered user name match the address and the family name of specific registered user information, and user registration is denied due to the specific registered user information being already registered,
the communication system displays, on the display unit, the registered user name.

9. The communication system according to claim 3,
wherein the server is configured to determine the index value independently of whether the entered data corresponding to a specific input item matches the data corresponding to the specific input item included in the registered user information.

10. A server configured to communicate with a terminal device including a display unit configured to display an image and an operation unit configured to receive user operations, comprising:
a storage device configured to store user information of registered users, the user information including data corresponding to multiple input items; and
a controller,
wherein the controller is configured to perform:
causing the display unit of the terminal device to display an input screen including multiple input elements, each configured to receive data corresponding to one of the multiple input items;
during an input state in which the input screen is displayed to allow data input to each of the multiple input elements before a registration instruction is received, obtaining data having been input into at least one of the multiple input elements;
determining, during the input state, an index value based on a proximity between the obtained data and the registered user information stored in the storage device;
causing, during the input state, the display unit to display an indicator, which is a visualization based on the index value, on the input screen being displayed on the display unit;
in response to receiving a registration instruction in association with the data corresponding to the multiple input items having been input to the multiple input elements, determining whether a registration condition is satisfied based on a comparison between the received data corresponding to the multiple input items and the data corresponding to the multiple input items included in the user information stored in the storage device; and
completing user registration by storing the user information, including the received data corresponding to the multiple input items, into the storage device as user information for a newly registered user when the registration condition is determined to be satisfied, wherein the user registration is not completed when the registration condition is determined not to be satisfied.

11. The server according to claim 10,
wherein the causing the display unit of the terminal device to display an input screen includes transmitting data for the input screen to the terminal device, thereby the terminal device displaying the input screen on the display unit based on the transmitted data of the input screen; and
wherein the causing, during the input state, the display unit to display an indicator includes transmitting data for the indicator to the terminal device, thereby the terminal device displaying the indicator on the display unit based on the transmitted data of the indicator.

12. A user registration method for a communication system including a terminal device provided with a display unit configured to display an image and an operation unit configured to receive user operations, and a server including a storage device configured to store user information of registered users, the user information including data corresponding to multiple input items,
wherein the method comprises:
causing the display unit of the terminal device to display an input screen including multiple input elements, each configured to receive data corresponding to one of the multiple input items;
during an input state in which the input screen is displayed to allow data input to each of the multiple input elements before a registration instruction is received, obtaining data having been input into at least one of the multiple input elements;
determining, during the input state, an index value based on a proximity between the obtained data and the registered user information stored in the storage device;
causing, during the input state, the display unit to display an indicator, which is a visualization based on the index value, on the input screen being displayed on the display unit;
in response to receiving a registration instruction in association with the data corresponding to the multiple input items having been input to the multiple input elements, determining whether a registration condition is satisfied based on a comparison between the received data corresponding to the multiple input items and the data corresponding to the multiple input items included in the user information stored in the storage device; and
completing user registration by storing the user information, including the received data corresponding to the multiple input items, into the storage device as user information for a newly registered user when the registration condition is determined to be satisfied, wherein the user registration is not completed when the registration condition is determined not to be satisfied.
